(19) United States
(12) Patent Application Publication
(10) Pub. No.: US 2009/0119988 A1
(43) Pub. Date: May 14, 2009

(54) Aerial plant planter

(76) Inventor: Emerlinda Helen Berrie, Los Angeles, CA (US)

Correspondence Address: Emerlinda Helen Berrie;#304, 1253 Barry Ave., Los Angeles, CA, 90025, US

(21) Appl. No.: 11/983,553

(22) Filed: Nov. 9, 2007

(51) Int. Cl. A01G 9/02; A01G 25/00; B28B 1/48

(52) U.S. Cl. 47/80; 47/83; 264/154

(57) ABSTRACT

An aerial plant planter comprising a wall and a flat bottom surface that formed the cavity for holding root structure of a plant and its growing medium with attached individual porous water chambers on the wall of the planter for storing quantity of water. Open spaces are created around the wall and bottom of the planter to provide sufficient airflow. Tops of the water chambers are open to supply humidity to the plants and for easy refilling. The flat bottom defines a plurality of risers for maximum air circulation and to prevent the plant from sitting on any excess water that may be present underneath the planter.

### BACKGROUND OF THE INVENTION

Containers for plants have been used for many years. Typically a planter consists of a watertight container with an open top, into which a plant and the growing materials are deposited. Most planters require periodic watering and other planters are designed to let the plants sit on water that eventually creates rotting or calcification on the root system of the plant that creates the unsightly browning of the leaves. This type of planter is not suitable for aerial plant or any plant sensitive to standing water.

Therefore, what is needed is a planter that will give aerial plants the elements necessary to grow well: humidity, slow release but constant supply of water and sufficient amount of airflow.

### SUMMARY OF THE INVENTION

In nature, aerial plants such as epiphytic orchids grow in humid and warm to cool environment with plenty of air circulation; attaching themselves to mostly trees with their roots expose. This present invention can provide the same elements to these aerial plants and create an effective environment to grow well. This aerial plant planter has one wall and one cavity to deposit the growing materials and support the root structure of the plant. Porous water chambers are distributed and attached onto the exterior or interior wall of the planter to store water. By capillary action, the water slowly but continually seeps through the porous wall of the water chambers and into the growing medium and to the root structure of the plant. Since the water chambers have open top, the water evaporates and humidifies the plants. The open-top water chambers also allow easy refilling. Open spaces are also created randomly on the wall and at the bottom of the planter to provide sufficient airflow and allowing the root system of the plant to grow and spread freely through the open spaces of the planter. Additionally, risers or support legs are created and distributed at the bottom of the planter for maximum air circulation and to prevent the plant from sitting on any excess water that may be present beneath the planter.

Also an object is to provide a planter for aerial plant made of common materials and easy to manufacture to thereby be inexpensive and requires very little maintenance. Though this planter is invented specifically for aerial plant, it also works well as regular planter with the benefit of the water chambers' watering system. This aerial plant planter can easily be converted as regular and typical planter and be used for ground plants such as ground orchids, ferns and others that require loose growing materials and sufficient amount of good drainage. By simply lining the cavity of this aerial plant planter with commonly available garden materials such as garden fabrics, moss, coconut fibers or any loose and porous material, this aerial plant planter can function as regular planter. This aerial plant planter can also be converted as hanging planter by threading or tying a string, rope or wire through the open spaces on the wall of the planter. As hanging planter this aerial plant planter is suitable for shallow root plants such as impatience and trailing plants such as ivy.

### BRIEF DESCRIPTION OF THE DRAWINGS

These and other advantages of the present invention are best understood with reference to the drawings, in which:

FIG. 1 shows a perspective of one embodiment of the present invention showing water chambers on the exterior wall of the planter;

FIG. 2 shows a perspective of one embodiment of the present invention showing water chambers on the interior wall of the planter and the variation of designs of open spaces on the wall of the planter;

FIG. 3 shows a perspective view of attaching the water chamber;

FIG. 4 shows a perspective view of how the design is slightly altered when the planter is made of non-porous material. The porous chamber is inserted into the water chamber holder.

### DETAILED DESCRIPTION OF THE PREFERRED EMBODIMENT

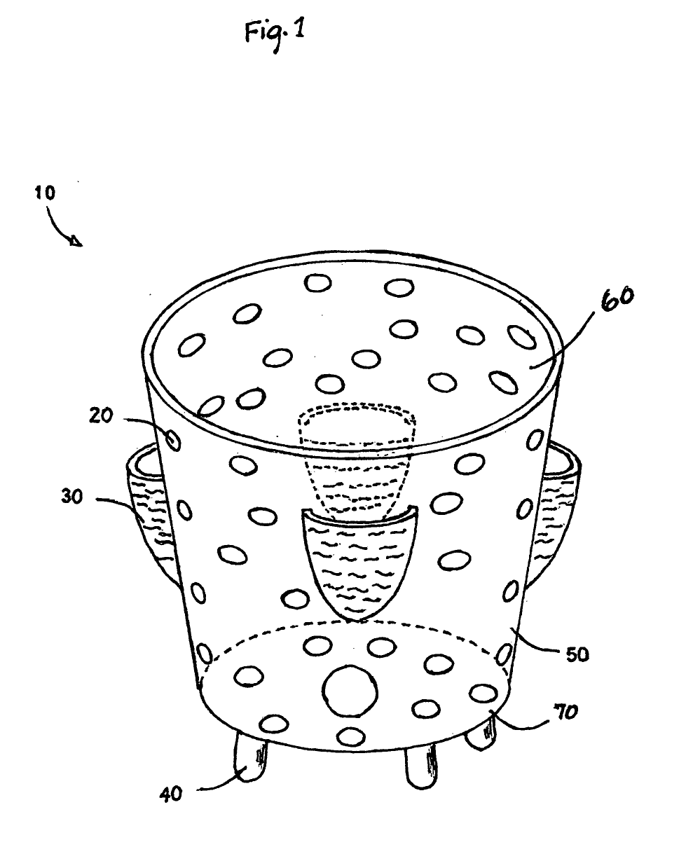

Referring now to FIG. 1, one embodiment of the present invention is described. For planter made of porous material, the body of the planter 10 has one wall 50, one cavity 60 and substantially flat bottom 70 to support the root structure of the plant and its growing materials.

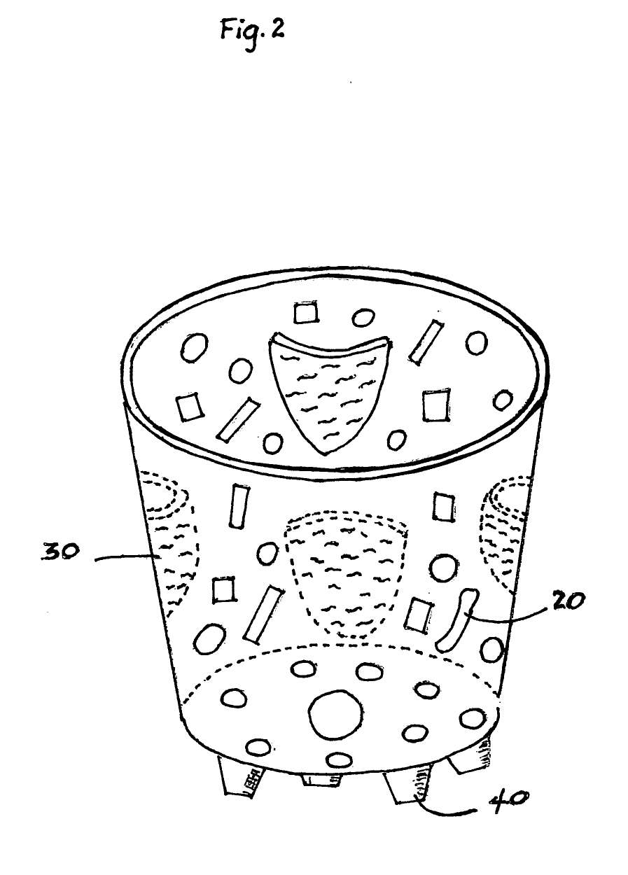

Around the wall 50 of the planter 10 individual porous water chambers 30 are distributed and attached onto the exterior wall as shown on FIG. 1 or interior wall as shown on FIG. 2 to store water. The stored water in the water chambers 30 slowly seeps through the porous water chamber 30, through the wall 50 of the planter 10 and into the growing medium and root structure of the plant. Since the tops of the water chambers 30 are open to the atmosphere, the water evaporates and humidifies the plants.

Multiple open spaces 20 are created around the wall 50 of the planter 10 and at the bottom 70. These open spaces 20 allow the air to flow in and out of the planter 10 thereby oxygenating the root system sufficiently.

Multiple risers or support legs 40 are created at the bottom 70 of the planter 10 to elevate the planter for maximum air circulation at the bottom and to prevent the plant from sitting on any excess water that may be present beneath the planter 10.

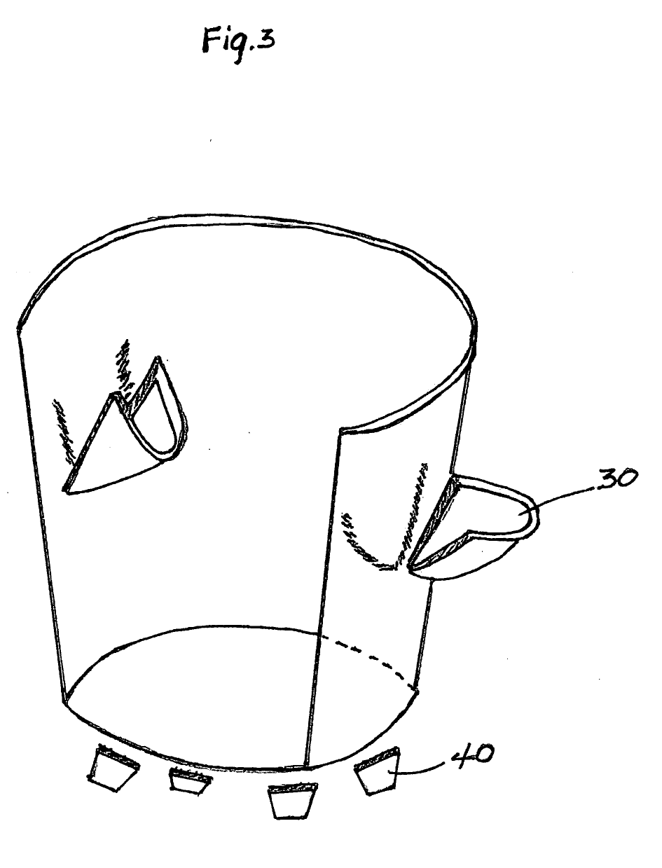

Referring to FIG. 3, illustrates how the water chambers 30 and the risers 40 are attached to the body of the planter 10. When this planter is made of clay, the sides of the water chambers 30 and risers 40 that attaches to the body of the planter are scored and attached to the scored side of the body of the planter using slip.

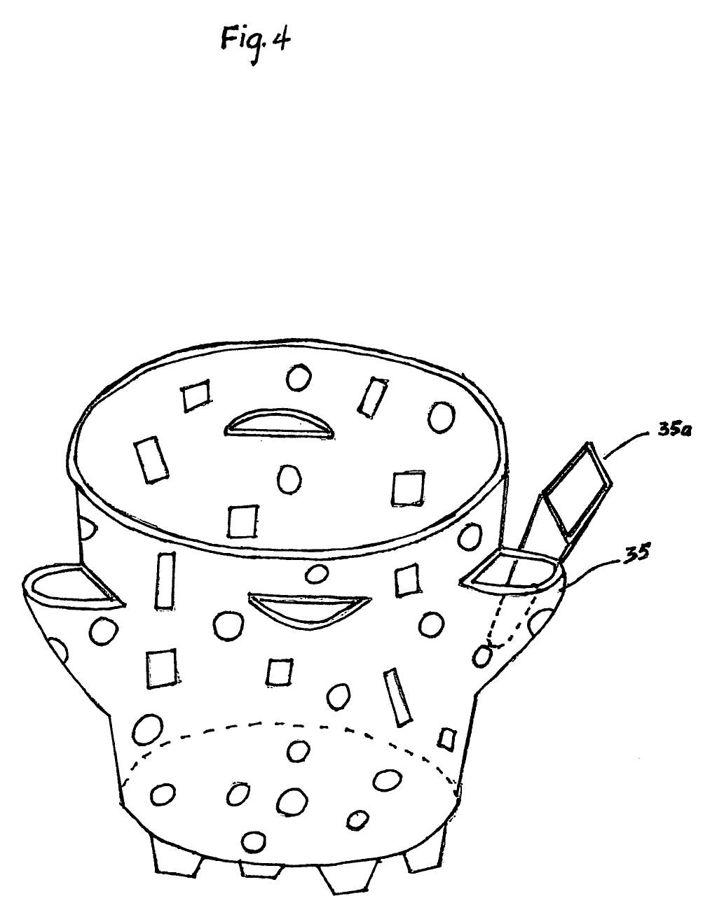

FIG. 4, shows how the planter is slightly altered when made of non-porous material such as plastic. Larger and protruding openings 35 are created and distributed around the wall of the planter 10. The large protruding openings 35 are shaped and designed as water chamber holders to hold and accommodate the separately made porous water chambers 35a. The separate and removable porous water chambers 35a are then inserted into the water chamber holders 35 to continually supply water to the plant.

This aerial plant planter embodying the present invention holds many advantages over typical prior art planters. No over-watering or rotting of the plants can occur in this planter because of the sufficient amount of good drainage. No drying-out of plants in this planter because of the constant supply of water from the water chambers 30.

This aerial plant planter can easily be converted into a regular planter for ground plants such as ground orchids, ferns and others that require loose growing materials and sufficient amount of good drainage. By lining the cavity of the planter with commonly available garden materials such as garden fabrics, mosses, coconut fibers or any loose and porous materials, this aerial plant planter works very well for plants with the added benefit of the water chambers' watering system. Additionally, this aerial plant planter can easily be converted as hanging planter by just threading or tying a rope, string or wire through the open spaces 20 on the wall 50 of the planter.

### NUMBER DESCRIPTION LIST

10 is an aerial planter
20 is an open space
30 is a water chamber
35 is a water chamber holder
35a is a removable water chamber
40 is a leg
50 is a wall
60 is cavity
70 is a bottom

What is claimed is:

1. An aerial plant planter adapted to house the root structure of a plant and to support its growing materials, the planter comprising a body with one wall and one cavity and substantially flat bottom.

2. The planter of claim 1, wherein the wall has attached individual topless water chambers when planter is made of porous material.

3. The planter of claim 1, further comprise a bottomless and topless water chamber holders designed as part of the wall of the planter to hold and accommodate the separately made porous water chambers when planter is made of materials impervious to water such as plastic.

4. The planter of claim 2, wherein water chambers are made of materials permeable to water such as clay or porous rubber.

5. The planter of claim 4, wherein open spaces are created around the water chambers when planter is made of porous material.

6. The planter of claim 4, further comprise open spaces on water chamber holders when planter is made of materials impervious to water to fully oxygenate the root structure of the plant in the planter.

7. The planter of claim 6, wherein open spaces on the wall of the planter are designed in various shapes and sizes and are also created randomly at the bottom of the planter.

8. The planter of claim 7, wherein open spaces at the bottom of the planter are created around multiple risers or support legs.

9. One method of making a self-watering aerial plant planter made of clay involves: (a) hand throwing a wedged clay to make a planter; (b) shaping the water chambers from a slab of clay; (c) scoring all sides of the shaped water chambers except the top when leather hard; (d) scoring the locations of the water chambers on the wall of the planter when leather hard; (e) attaching the scored water chambers onto the scored location of the wall of the planter using slip; (f) shaping the risers or support legs from a wedged slab or extruded clay; (g) scoring the sides of the risers that attach to the bottom of the planter and attaching them using slip; (h) creating open spaces on the wall and bottom of the planter and around the water chambers and risers of the planter; (i) firing the greenware when it is completely dry and only to a point where it is still porous.

10. A method of manufacturing as set forth in claim 9, can be further accomplished comprising: (a) pouring plaster onto the original constructed aerial plant planter to create a mold; (b) pressing a slab of clay onto the dry mold to reproduce the planters; (c) shaping the water chambers from slab of clay with its sides scored when leather hard; (d) attaching the water chambers onto the scored location of the wall of the planter using slips (e) shaping the risers from a slab or extruded clay, scored and attached to the bottom of the planter using slip; (f) creating open spaces on the wall and bottom of the planter and around the water-chambers and risers; (g) firing the greenware when it is completely dry only to a point where it is still porous.

11. Another method of manufacturing this aerial plant planter using material impervious to water such as plastic is using plastic molding process. With this process, the design remains the same except that the water chambers are now made separately and removable but are still made of porous material such as clay or porous rubber. Large protruding openings on the wall are shaped and serve as bottomless and topless water chamber holders to hold and accommodate the separately made porous water chambers.
